(19) United States
(12) Patent Application Publication
(10) Pub. No.: US 2016/0316941 A1
(43) Pub. Date: Nov. 3, 2016

(54) Modular Frame System and Method

(71) Applicant: Hangzhou Classic-Maxim Arts & Crafts Co., Ltd., Hangzhou (CN)

(72) Inventor: Yun Luo, Hangzhou (CN)

(73) Assignee: Hangzhou Classic-Maxim Arts & Crafts Co., Ltd., Hangzhou (CN)

(21) Appl. No.: 15/205,746

(22) Filed: Jul. 8, 2016

Related U.S. Application Data
(63) Continuation-in-part of application No. 14/220,729, filed on Mar. 20, 2014.
(60) Provisional application No. 61/846,516, filed on Jul. 15, 2013.

(30) Foreign Application Priority Data
Apr. 15, 2014 (CN) 201410148672.7
May 22, 2014 (CN) PCT/CN2014/078086

(51) Int. Cl. A47G 1/10; B44D 3/00; B44D 3/18

(52) U.S. Cl. CPC A47G 1/10; B44D 3/185; B44D 3/00

(57) ABSTRACT

The present invention is directed toward a system, an apparatus, and a kit for facilitating the mounting, transporting, and replacing of a canvas. The kit contains the components in a fashion that is well organized in an enclosure designed to hold the parts of a modular frame system, and a structure for holding the canvas. The modular frame system includes a modular frame assembly and elastic cords. The modular frame assembly includes connectors and frame parts that form a frame structure for securing down a canvas, and thereby forming a canvas display. The canvas is secured to the modular frame assembly by elastic cords that attach to rivet holes on the sides of the canvas; the elastic cords pull the canvas tightly over the modular frame assembly so that the canvas is displayed properly. The rivet holes may have a protective structure attached to protect the canvas from damage.

### CROSS-REFERENCE TO RELATED APPLICATIONS

This application is a continuation-in-part of U.S. patent application Ser. No. 14/220,729, filed Mar. 20, 2014, which claims the benefit of U.S. Provisional Application No. 61/846,516, filed Jul. 15, 2013, and this application is also a continuation-in-part of International Application No. PCT/CN2014/078086, filed May 22, 2014, which claims benefit of China Application No. 201410148672.7, filed Apr. 15, 2014. The disclosures of all of the above applications are incorporated by this reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

1. Field of Invention

The present invention relates to improvements in artists' equipment, and more particularly, to novel means for mounting, transporting, and replacing a canvas display.

2. Description of Related Art Including Information Disclosed Under 37 C.F.R. 1.97 and 1.98

Canvas displays have become increasingly popular as decorative paintings to be displayed in homes, offices, and other places. This type of decorative artwork is generally printed or painted artwork on a canvas, and canvases are popularly used by artists as a painting surface. Modern canvases are usually made of cotton or linen, and are stretched and attached to a wooden frame, also known as a stretcher bar, by staples. Generally, there is no exterior structure that protects the canvas (and the image on the canvas) from being damaged because of the method of displaying the canvas.

Currently, when a canvas display is transported, the canvas display is wrapped up entirely and then transported. During this transportation process, the canvas may be damaged through the wrapping. Also, the canvas display requires the use of large amounts of space during transport. These problems stem from the canvas being permanently attached to the wooden frame.

### BRIEF SUMMARY OF THE INVENTION

Disclosed herein is a system, apparatus, and related kit for the purpose of facilitating the transporting, mounting, and replacing of a canvas display.

In accordance with one embodiment of the present invention, a system, apparatus and kit for facilitating the transporting, mounting, and replacing of a canvas display are provided which substantially makes assembly, disassembly, and packaging of a canvas display easier and more space-efficient.

In accordance with another embodiment, a canvas frame system for facilitating the transporting, mounting, and replacing of a canvas display is provided. A canvas frame system for facilitating dismounting, transporting, and replacing of a canvas is disclosed, comprising a modular frame assembly, and a plurality of elastic cords, wherein the canvas comprises at least two rivet holes, located at sides of the canvas, and said plurality of elastic cords connects at least two rivet holes. Other embodiments include a grommet attached to each of the rivet holes, the plurality of elastic cords made of plastic, the modular frame assembly made of plastic, the canvas comprising at least one folded side, at least one support piece inserted into the folded side, a support piece comprising a corresponding rivet hole, and the plurality of elastic cords comprising hooks attached to the ends of the cords.

In accordance with another embodiment, a modular frame assembly for facilitating the transporting, mounting, and replacing of a canvas display is provided. A modular frame assembly for a canvas display, for facilitating dismounting, transporting, and replacing of the canvas display, comprising at least one connector, a plurality of side frame parts, wherein the plurality of side frame parts connect to the at least one connector in accordance with another embodiment, a kit for facilitating the transporting, mounting, and replacing of a canvas display is provided. Other embodiments include the connector comprising a three-way connector, the connector comprising a four-way connector, the connector comprising a corner connector, the connector comprising ridges, the connector comprising a hook, and further comprising a corner module.

In accordance with another embodiment, a modular frame kit is provided. The modular frame kit comprises at least one package of a plurality of defined compartments, wherein each compartment serves as a dedicated storage location, at least one three way connector, a plurality of side frame members; and a plurality of elastic cords. Other embodiments include further comprising a four-way connector, further comprising a corner connector, further comprising a corner module, and further including a tubular structure for containing a canvas.

At least one advantage attributable to novel aspects of the present disclosure is the scalability of the present invention as compared to the current state of the art in canvas display frames. Prior canvas displays require a frame with a predetermined size, and the size of the frame is not scalable when a canvas to be displayed does not fit the dimensions of the pre-sized frame. The present invention provides the scalability for canvas frames, through the use of a modular frame assembly. A modular frame assembly of the present invention provides numerous ways to structure a frame for a canvas display, and the modular frame assembly may be constructed or deconstructed to provide this scalability.

Another advantage attributable to novel aspects of the present disclosure is the modularity of the present invention as compared to the current state of the art in canvas display frames. As mentioned, prior canvas displays require a frame with a predetermined size, and when the canvas is attached to the frame, the canvas is not easily removed. Therefore, when the canvas display needs to be transported, any image on the canvas may be damaged during the transportation, even with careful packaging of the canvas display, because the canvas is still attached to the frame and the frame itself cannot be broken down. The present invention provides a modular frame assembly, so that a canvas may be mounted onto the frame assembly for display, and the modular frame assembly may be deconstructed for transport of the canvas display. The present invention also provides a kit that provides the modular frame assembly and a suitable structure for transporting the canvas and the modular frame assembly.

### BRIEF DESCRIPTION OF THE DRAWINGS

The present invention will be more fully understood by reference to the following detailed description of the preferred embodiments of the present invention when read in conjunction with the accompanying drawings, wherein:

FIG. 1 illustrates a back view of an exemplary embodiment of a modular frame system with two rows of rivet holes, and elastic cords connecting the two rows of rivet holes.

FIG. 2 illustrates a schematic view of an exemplary embodiment of a modular frame system with two straight support pieces.

FIG. 3 illustrates a schematic view of a modular frame system where the elastic cord uses hooks to connect the rivet holes according to one embodiment.

FIG. 4 shows a perspective view of an exemplary embodiment of a modular frame system.

FIG. 5 shows a perspective view of a side frame part of a modular frame system according to one embodiment.

FIG. 6 shows a perspective view of a corner frame part of a modular frame system according to one embodiment.

FIG. 7 shows a perspective view of a three way connector part of a modular frame system according to one embodiment.

FIG. 8 shows a perspective view of a four-way connector part of a modular frame system according to one embodiment.

FIG. 9 illustrates a back view of an exemplary embodiment of a modular frame system with a stretched canvas.

FIG. 12 illustrates a back view of a modular frame assembly with parts not connected and with an arrangement of the elastic cords of the modular frame system in one embodiment.

FIG. 10 illustrates a perspective view of a modular frame assembly according to one embodiment.

FIG. 11 illustrates a front view of the parts of a modular frame kit in accordance to one embodiment of the present invention.

FIG. 13 illustrates a front view of the parts of a circular nodular frame kit in accordance to one embodiment of the present invention.

FIG. 14 illustrates a front view of the parts of a quadrilateral modular frame kit in accordance to one embodiment of the present invention

FIG. 15 illustrates a back view of a corner of a modular frame kit in accordance to one embodiment of the present invention.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper.” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, or otherwise reserves all copyright rights whatsoever.

Referring to the drawings, embodiments of the present invention will be described below.

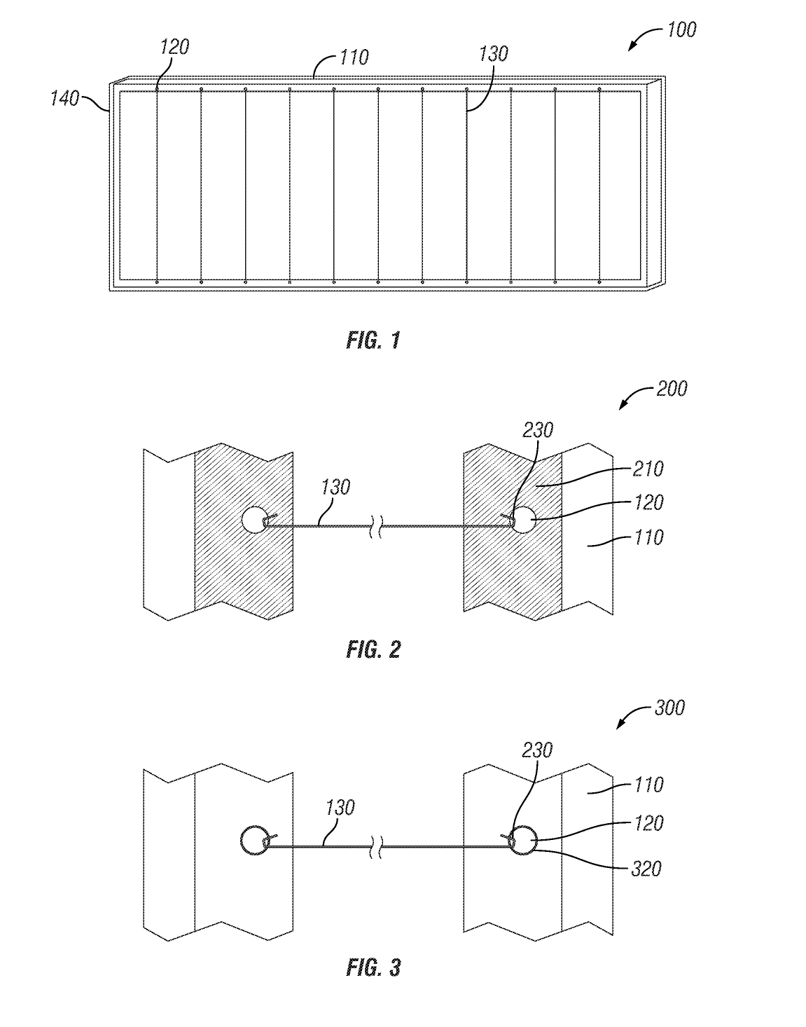

FIG. 1 illustrates a back view of an exemplary embodiment of a modular frame system with two rows of rivet holes, and elastic cords connecting the two rows of rivet holes. The modular frame system is comprised of a frame, a canvas with rivet holes, and elastic cords that connect the rivet holes. The frame provides the support structure for the canvas. The frame may be made of wood, metal, plastic, or any suitably rigid material. Each side of the frame may have various shapes in cross-section (e.g., square, circle, etc.). The sides of the frame may be detachably connected to the other sides of the frame.

According to the present exemplary embodiment, the canvas may be made of paper, fabric, or any other suitable material. The rivet holes are located near the edges of the canvas. The system may provide ferrules or grommets in order to prevent chaffing from the elastic cords. Alternatively, the method of creating the rivet holes may prevent chaffing. For example, after the rivet holes are created, reinforcement circlets may be applied to the rivet holes to prevent damage. Other protective structures may be applied to the rivet holes in order to prevent damage to the canvas.

In the present exemplary embodiment, a first row of rivet holes are located on a first side of the canvas, and a second row of rivet holes are located on a second side of the canvas. In the present embodiment, the first side of the canvas is parallel to the second side, so that the lengths of the elastic cords connecting the rivet holes are perpendicular to the first and second sides of the canvas. The rivet holes may be spaced evenly along the sides of the canvas. In another embodiment, rivet holes are located on all sides of the canvas and the lengths of the elastic cords may intersect the lengths of other elastic cords. In yet another embodiment where the canvas is stretched over a circular frame, rivets holes are located near the circumference of the canvas, and the elastic cords may intersect each other.

The elastic cords connect the rivet holes of the canvas so that elastic strength of the elastic cords stretches the canvas over and behind the frame. By stretching the canvas over and behind the frame with elastic cords, the front side of the canvas can be viewed correctly without sagging or wrinkling in the canvas. The elastic cords may be made of plastic, cloth, rubber, ductile metal, or any other suitably elastic material. Additional materials the elastic cords may be constructed from include nylon, polyester, or polypropylene. The length and diameter of the elastic cords may depend on the material from which the elastic cord is constructed. The elastic cords are attached to hooks on both ends, and the hooks connect to the rivet holes of the canvas. The hooks themselves may be made of metal, plastic, or any suitable rigid material. The elastic cords connect one side of the canvas to another side of the canvas, and may be arranged in any manner that pulls the canvas over and behind the frame to allow the front side of the canvas to remain smooth and without sagging or wrinkling.

The number of elastic cords used in the system corresponds with the size of the canvas. Larger canvases may require more elastic cords in order to ensure a taut front side of the canvas. However, the arrangement of elastic cords may increase or decrease the number of elastic cords.

FIG. 2 illustrates a schematic view of an exemplary embodiment of a modular frame system with two straight support pieces.

According to this exemplary embodiment of the modular frame system, the edges of the canvas are folded over and are connected to the canvas. A straight support piece is inserted into the channel created by the connected fold in the canvas. The width of the folded over edge corresponds to the width of the straight support pieces, so that the straight support piece does not move while in the channel formed by the folded over canvas. Rivet holes may be created before or after insertion of the straight support piece. If both the canvas and the straight support have rivet holes before the straight support piece is inserted into the channel, the rivet holes of the straight support piece should align with the rivet holes of the canvas so that the hooks of the elastic cords may pass through both the canvas and the straight support piece.

The canvas channel may be created by sewing the canvas edge to the canvas itself. Alternatively, an adhesive may be used to connect the edge of the canvas to the canvas itself to form a channel. One of ordinary skill would know how to connect the canvas edge to the canvas to create a channel formed by the folded over canvas.

The straight support piece provides structural support for the canvas during the transport of the canvas and during the mounting of the canvas onto the frame. The straight support piece may be made of plastic, metal, wood, bamboo, or any suitably rigid material. The rigidity of the straight support piece also assists in the prevention of chaffing of the canvas by the elastic cord. The straight support piece may have various shapes in cross-section (e.g., square, circle, etc.).

The length of the straight support piece should not exceed the length of the canvas to jut out of the channel created by the canvas. An oversized straight support piece would affect the aesthetics of the canvas since the straight support piece would extend from the edges of the canvas. An oversized straight support piece may also affect the structural support provided by the frame and the transportation method of the modular frame system.

According to another exemplary embodiment of the modular frame system, the width of the channel formed by the folded over canvas is greater the width of the straight support piece. The rivet holes are located on two sides of the channel, so that if the channel were to be flattened, each pair of rivet holes (one on each side of the channel) lines up so that the hooks of the elastic cords pass through the rivet holes. In this particular embodiment, the straight support piece does not have rivet holes for the hooks of the elastic cords through which the hooks of the elastic cords pass. So while this particular embodiment provides a straight support piece inserted into the folded edge, the straight support piece provides no protection from chaffing of the hooks against the rivet holes like in other embodiments but provides an initial support structure for securing the canvas to the frame. The straight support piece may then be removed from the channel formed by the canvas to reduce the weight of the entire canvas display.

In another embodiment of the invention, a second straight support piece may be inserted into a channel formed by another fold created on another side of the canvas, so that the two straight support pieces are parallel. By inserting a second straight support piece parallel to the first, the straight support pieces provide structural stability in one dimension of the canvas.

FIG. 3 illustrates a schematic view of a modular frame system where the elastic cord uses hooks to connect the rivet holes according to one embodiment. The modular frame system uses ferrules, grommets or any other suitable structure that would assists in preventing chaffing of the rivet hole by the elastic cord.

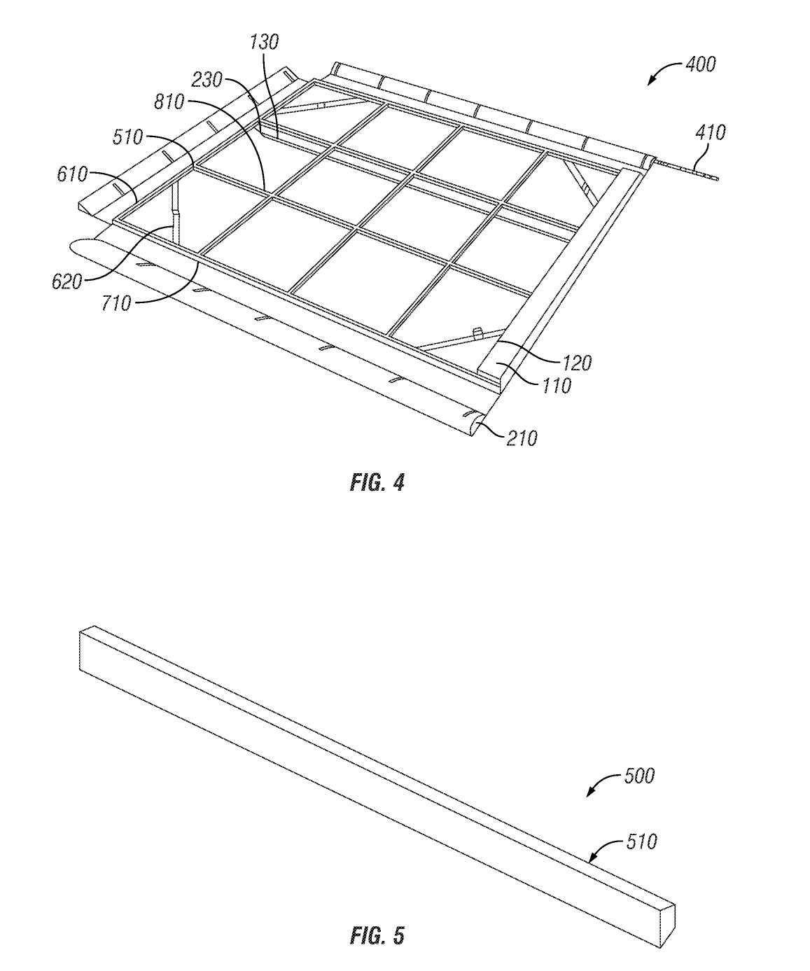

FIG. 4 shows a perspective view of an exemplary embodiment of a modular frame system. According to the exemplary embodiment, the modular frame system is comprised of a canvas with rivet holes, a modular frame assembly, and elastic cords that connect the rivet holes of the canvas.

The modular frame assembly, like the frame of FIG. 1, provides support structure for the canvas. The modular frame assembly is comprised of corner modules, side frame parts, three-way connectors, and four way connectors. The corner modules connect to three-way connectors, and the three-way connectors connect to other assembly parts, such as the side frame parts. The side frame parts connect either to another three way connector or to a four-way connector. The four way connectors connect to side frame parts, and structurally support the borders of the modular frame assembly. The parts of the modular frame assembly may be made of plastic, metal, wood, or any suitably rigid material. Each part of the modular frame assembly may be detachably connected to other parts of the frame assembly.

In another embodiment, the size of the modular frame assembly may be modified depending on the size of the canvas. In order to accommodate different sizes of canvases, more or less parts of the modular frame assembly may be included. For a rectangular canvas, the modular frame assembly requires four corner modules, but the length and/or height may modify the number of side frame parts, three way connectors, and four way connectors needed in order to provide a frame for the rectangular canvas. For example, a small rectangular canvas may require the four corner modules be connect together via four three way connectors, without any side frame parts between the corner modules.

In alternative embodiments, the modular frame assembly may provide quarter-circle side frame parts. Quarter circle side frame parts connects to a three-way connector, and multiple quarter circle side frame parts connected by three way connectors would form a circular frame assembly. The circular frame assembly may comprise straight side frame parts that connect to a four-way connector and the multiple three-way connectors so that the edge of the circular frame assembly is structurally supported. Other embodiments of the modular frame system provide different shapes for the constructed modular frame assembly.

The canvas, like the canvas of FIG. 1, may be made of paper, fabric, or any other suitable material, and may have any shape. Rivet holes are located near the edges of the canvas. In the present exemplary embodiment of the modular frame system as shown by FIG. 4, the canvas is comprised of a flat portion, and four folded edges. The four folded edges form channels for a straight support piece to be inserted. The rivet holes are located on the four folded edges of the canvas. Rivets holes appear on both sides of the folded edges, so that when the folded edge is flattened, the rivet holes on both sides align to allow the elastic cord to pass through.

Like the elastic cords shown in FIG. 1, the elastic cords connect the rivet holes of one side of the canvas to the rivet holes of another side of the canvas. The elastic cords may be arranged in any manner to pull the canvas back and over the modular frame assembly and keep the front side of the canvas taut.

FIG. 5 shows a perspective view of a side frame part of a modular frame system according to one embodiment. The side frame part may be made of wood, metal, or any suitably rigid material, and may be of any length. Each side frame part may have various shapes in cross-section (e.g., square, circle, etc.). The side frame part may be wholly or partially hollow, or solid. Because the side frame part connect to a connector part (e.g., the three-way connector or the four-way connector), the ends of the side frame part may be hollow to allow the connector to be slidably inserted. Alternatively, the ends of the side frame part may be slidably inserted into a connector, and the connector has a hollow portion for this insertion.

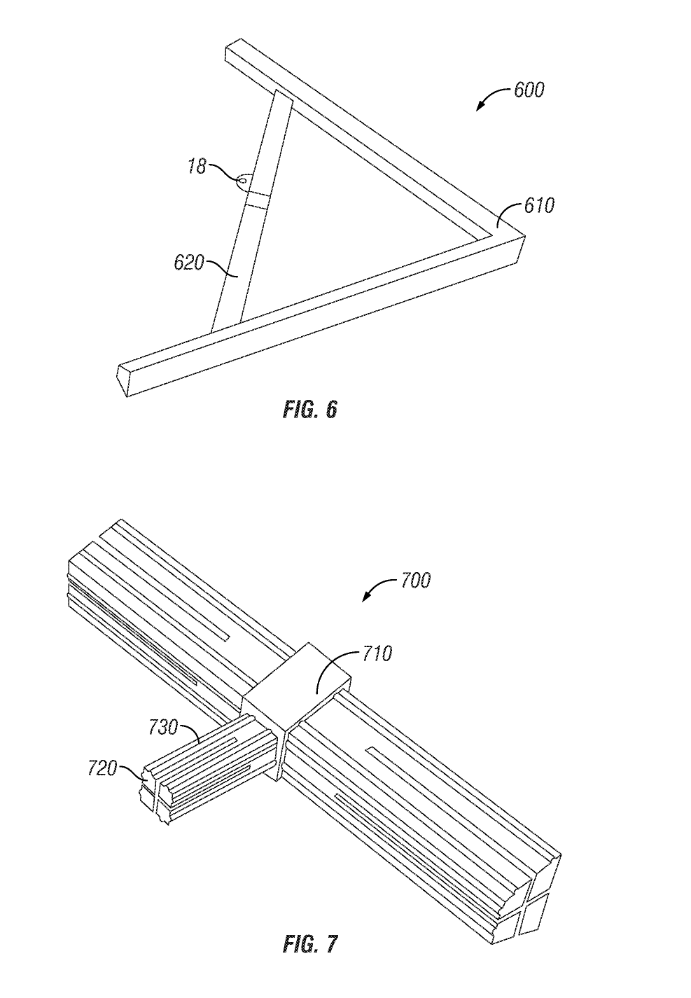

FIG. 6 shows a perspective view of a corner frame part of a modular frame system according to one embodiment. The corner module, like the same frame parts of the modular frame system, are connected to connectors, e.g., the three-way connectors. The corner module may be made of wood, metal, or any suitably rigid material, and each length of the corner module may be of any length. The two lengths of the corner module connect to form any angle, and in FIG. 6, the corner module forms a right angle. The corner module may be wholly or partially hollow, or solid. Because the corner modules connect to a connector part, the ends of the corner module may be hollow to allow the connector to be slidably inserted. Alternatively, the ends of the corner module may be slidably inserted into a connector, and the connector has a hollow portion for this insertion.

In one embodiment of the modular frame system, the corner module has a corner module insert and a frame hanger. The insert may be made of plastic, wood, metal, or any suitably rigid material. The insert is located between the two lengths of the corner module, and the frame hanger is attached to the insert. The frame hanger allows the module frame system to be mounted onto a wall or any other structure for display. The frame hanger may be made of metal, plastic, or any suitably rigid material. In alternative embodiments, the frame hanger may be attached to other parts of the modular frame assembly, such as the connectors.

FIG. 7 shows a perspective view of a three way connector part of a modular frame system according to one embodiment. The three way connector connects side frame parts and corner modules of the modular frame system. In this particular exemplary embodiment, the three lengths of the three way connector has ridges protruding outward from the lengths, and correspondingly, any piece to be connected to the three-way connector has valleys that correspond with the ridges of the three way connector. When slidably inserted into either a side frame part or a corner module, these ridges help maintain the connection between the three way connection and either the side frame part or the corner module. Alternatively, the ends of either the side frame part or the corner module has the ridges shown in FIG. 7, and the three way connector is correspondingly shaped to receive the ridges when the parts are connected. Like other parts of the modular frame assembly, the three way connector may be made of plastic, wood, metal, or any suitably rigid material.

In alternate embodiments, the ridges of the three way connector may provide a locking mechanism so after the connector and either the side frame part or the corner module connect, the two pieces are locked together so that the pieces do not accidentally disconnect.

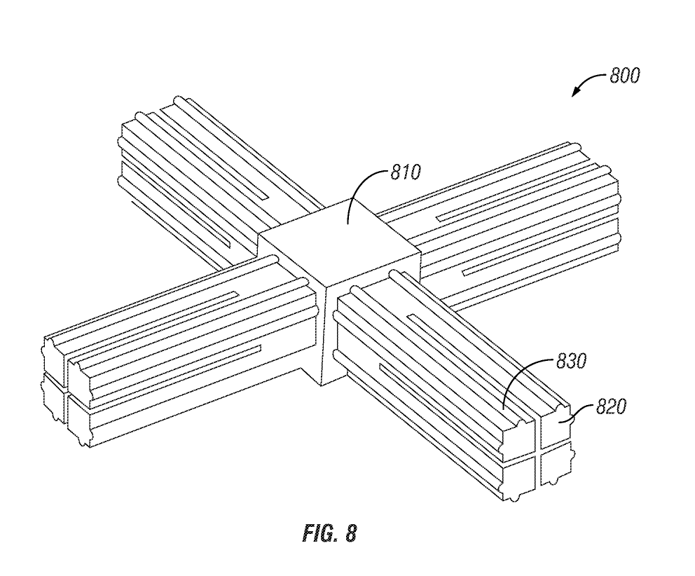

FIG. 8 shows a perspective view of a four-way connector part of a modular frame system according to one embodiment. Like the three-way connector, the four-way connector connects side frame parts, and may optionally connect corner modules. Similar to the three-way connector shown in FIG. 7, the four lengths of the four-way connector has ridges protruding outward from the lengths, and correspondingly, any piece to be connected to the four-way connector has valleys that correspond with the ridges of the four-way connector. When slidably inserted into either a side frame part or a corner module, these ridges help maintain the connection between the four-way connector and either the side frame part or the corner module. Alternatively, the ends of either the side frame part or the corner module has ridges as shown in FIGS. 7 and 8, and the four-way connector is correspondingly shaped to receive the ridges when the parts are connected. Like other parts of the modular frame assembly, the four-way connector may be made of plastic, wood, metal, or any suitably rigid material.

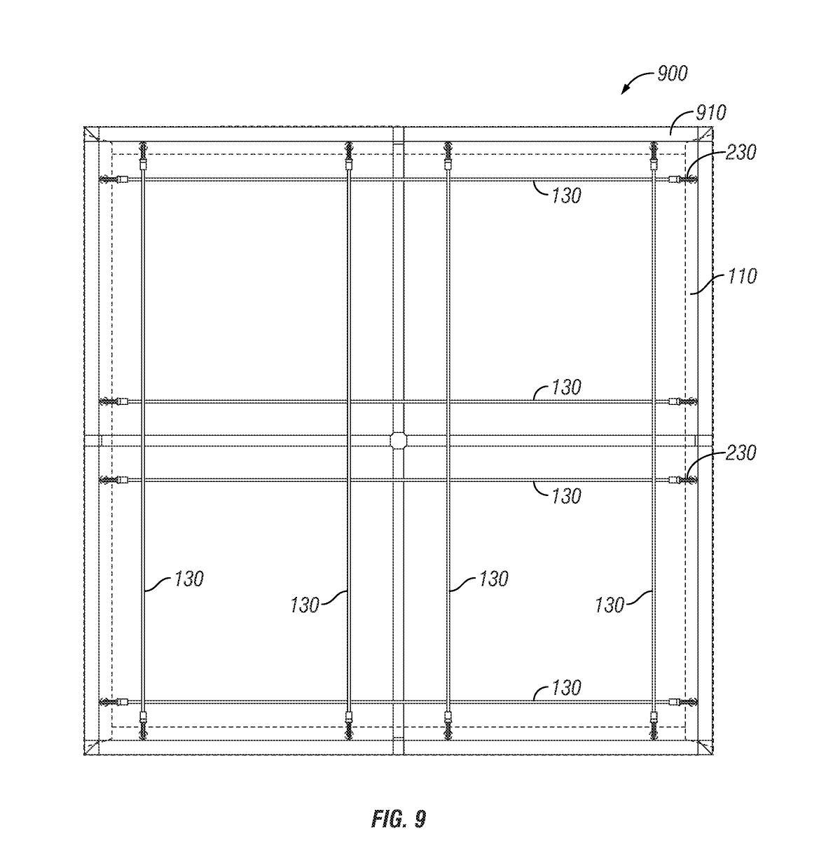

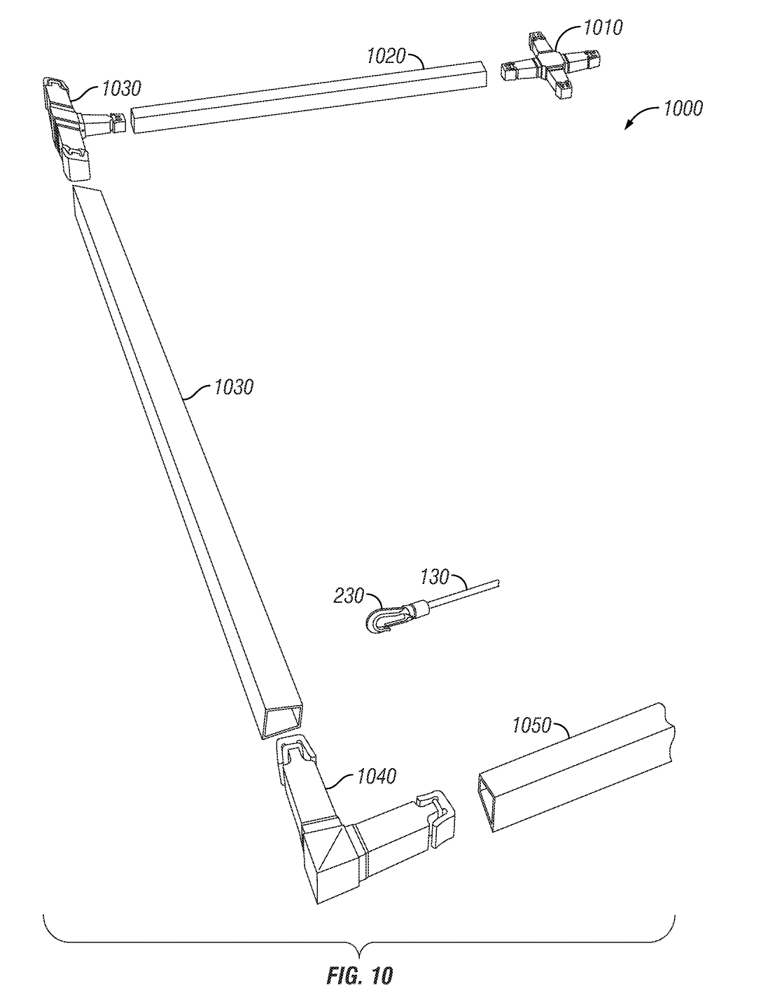

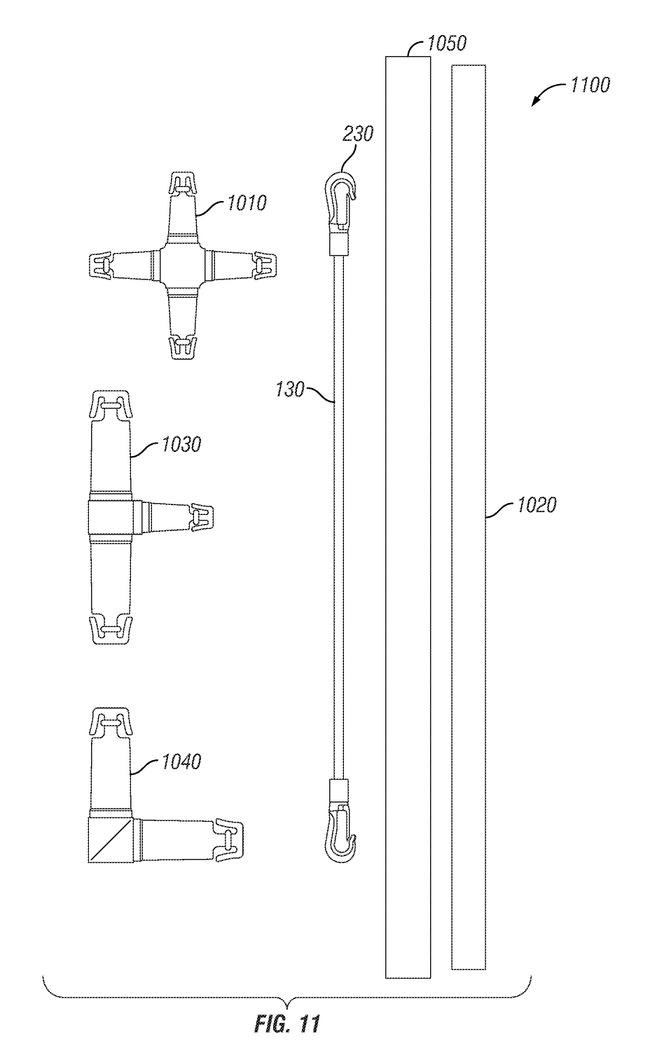

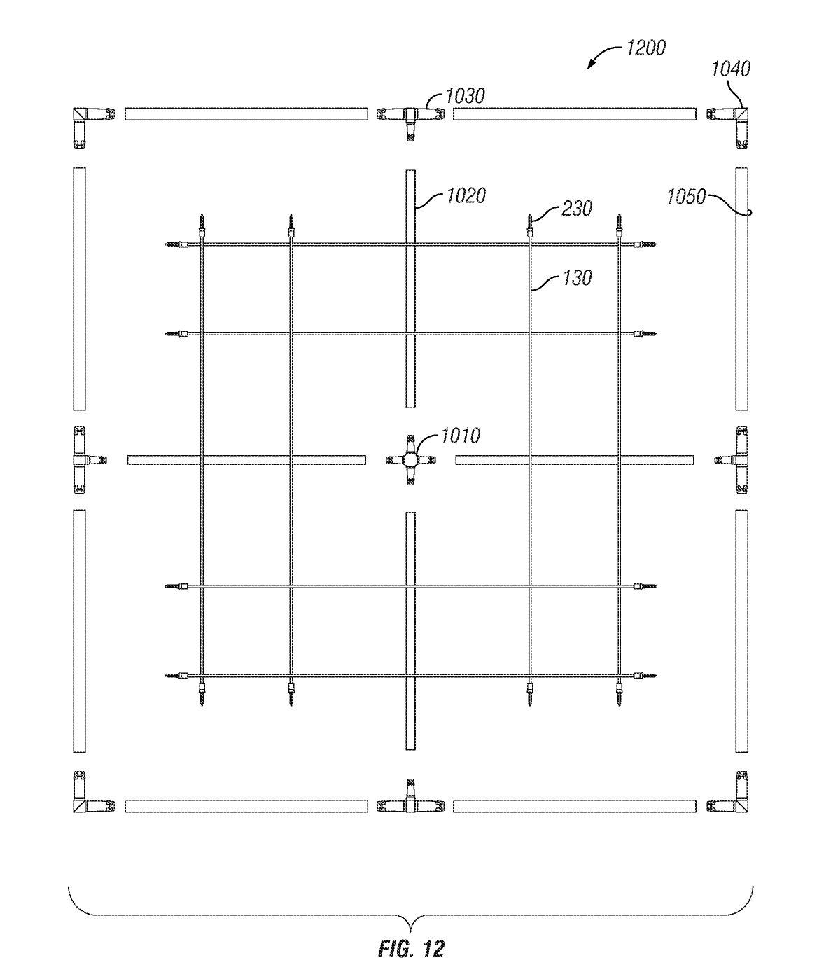

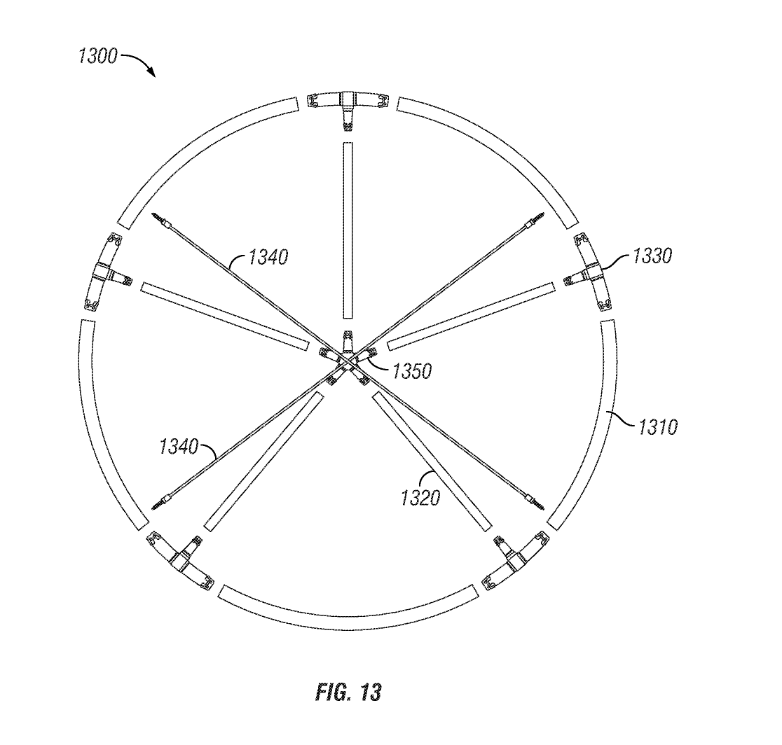

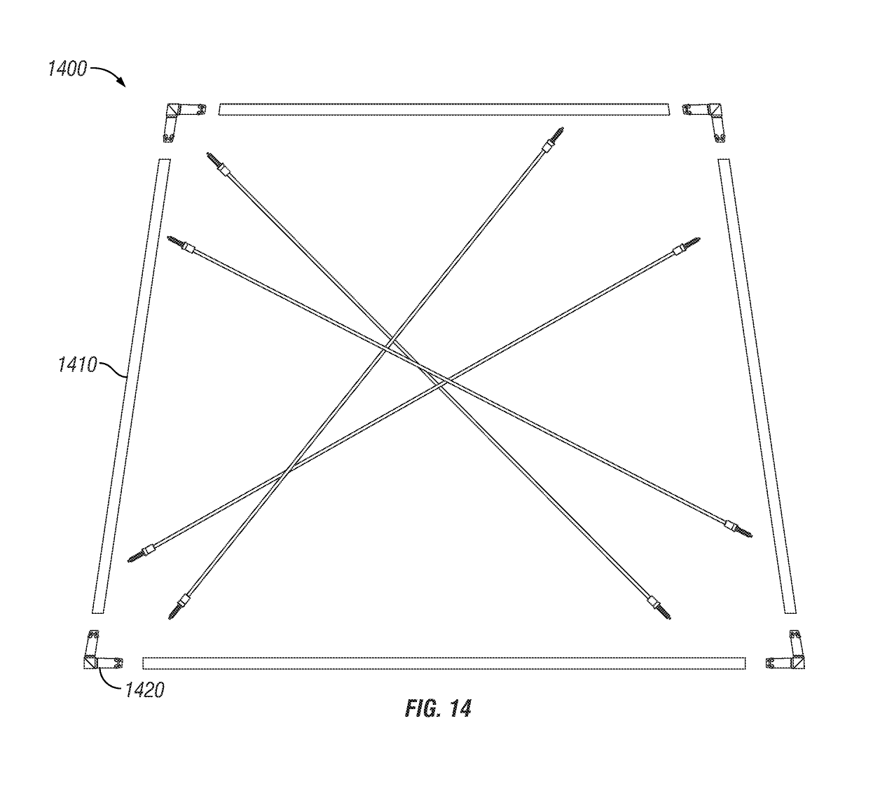

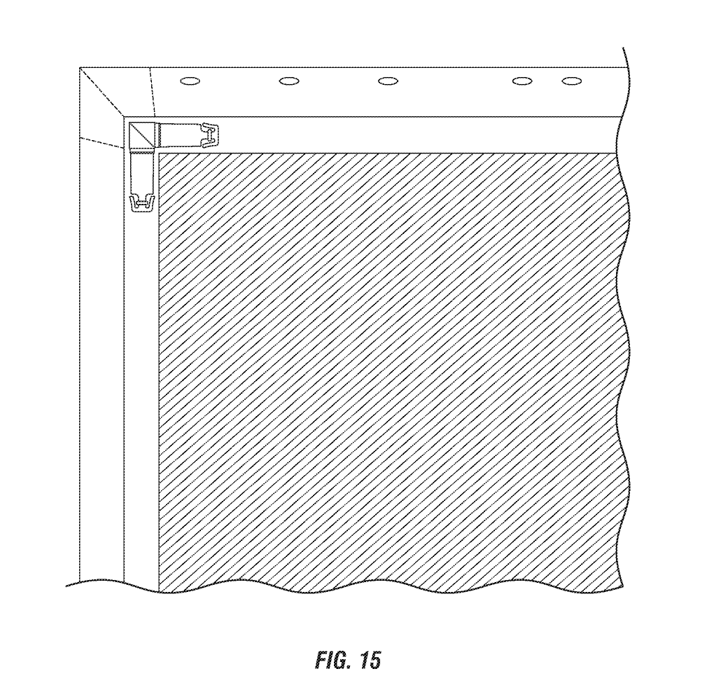

FIG. 9 illustrates a back view of an exemplary embodiment of a modular frame system with a stretched canvas. According to this exemplary embodiment, the modular frame system comprises a modular frame assembly, a canvas with rivet holes, and elastic cords that connect to the rivet holes of the canvas. FIG. 9 illustrates the modular frame system assembled with the canvas properly attached to the frame assembly with the elastic cords. FIG. 12 illustrates an unassembled embodiment of the modular frame assembly with the elastic cords arranged

The canvas, like the canvas of FIG. 1, may be made of paper, fabric, or any other suitable material. The rivet holes are located near the edges of the canvas. The system may provide ferrules or grommets in order to prevent chaffing from the elastic cords. Alternatively, the method of creating the rivet holes may prevent chaffing. For example, after the rivet holes are created, reinforcement circlets may be applied to the rivet holes to prevent damage.

According to the present embodiment, the canvas is pulled over the modular frame assembly and arranged so that when the elastic cords are attached, the lengths of the elastic cords intersect the lengths of other elastic cords. The corners of the top and bottom edges of the canvas are hidden by the corners of left and right edges of the canvas after the top and bottom edges of the canvas have been folded. The overlap of the edges of the canvas at any corner of the modular frame assembly may be at any angle, e.g. 45 degrees or 90 degrees. One of ordinary skill in the art would know how to create a folded corner of the canvas over the modular frame assembly.

In the present exemplary embodiment, rows of rivet holes are located on all four sides of the canvas. In the present embodiment, the lengths of the elastic cords connecting the rivet holes are perpendicular to each other, so as to stretch the canvas tightly over and behind the modular frame assembly. The rivet holes may be spaced evenly along the sides of the canvas. In another embodiment, the canvas has more than sixteen rivet holes as shown in FIG. 9. In yet another embodiment where the canvas is stretched over a circular frame, rivets holes are located near the circumference of the canvas, and the elastic cords may interest each other.

Like the elastic cords shown in FIG. 1, the elastic cords connect the rivet holes of one side of the canvas to the rivet holes of another side of the canvas. The elastic cords may be arranged in any manner to pull the canvas back and over the modular frame assembly and keep the front side of the canvas taut.

FIG. 12 illustrates a back view of a modular frame assembly with parts not connected and with an arrangement of the elastic cords of the modular frame system in one embodiment. The modular frame assembly. The modular frame assembly, like the modular frame assembly illustrated in FIG. 4, is comprised of corner connectors, three-way connectors, four way connectors, and side frame parts. The corner connectors, in this embodiment, are similar to the three-way connectors, and the corner connectors connect directly to a side frame part. Similar to the three-way connectors and four way connectors as shown in FIG. 4, the three way connectors and four way connectors of the exemplary embodiment connect directly to the side frame parts to form a partitioned and modular frame assembly. Because this modular frame assembly embodiment uses corner connectors instead of corner modules, the frame assembly requires fewer frame parts and reduces the amount of time required for frame assembly. The parts of the modular frame assembly may be made of plastic, metal, wood, or any suitably rigid material. Each part of the modular frame assembly may be detachably connected to other parts of the frame assembly.

In another embodiment, the size of the modular frame assembly may be modified depending on the size of the canvas. In order to accommodate different sizes of canvases, more or less parts of the modular frame assembly may be included. For a rectangular canvas, the modular frame assembly requires four corner connectors, but the length and/or height may modify the number of side frame parts, three way connectors, and four way connectors needed in order to provide a frame for the rectangular canvas. For example, a small square canvas may require the four corner connectors be connect to four side frame parts, and creates a small square frame assembly without any structure within the borders of the assembly.

In alternative embodiments, the modular frame assembly may provide quarter-circle side frame parts. Quarter circle side frame parts connects to a three-way connector, and multiple quarter circle side frame parts connected by three way connectors would form a circular frame assembly. The circular frame assembly may comprise straight side frame parts that connect to a four-way connector and the multiple three-way connectors so that the edge of the circular frame assembly is structurally supported. Other embodiments of the modular frame system provide different shapes for the constructed modular frame assembly.

FIG. 10 illustrates a perspective view of a modular frame assembly according to one embodiment. According to this embodiment, the connectors of the frame assembly (e.g., corner connectors, three way connectors, and four-way connectors) connect directly to the side frame parts. The side frame parts are hollow at the ends in order to receive the ends of the connectors, and the ends of the connectors are inserted into the side frame parts. Like previous embodiments, all parts of the modular frame assembly may be made of plastic, wood, metal, or any suitably rigid material

The connectors of the modular frame assembly include a hook that when the connector end is inserted into the side frame part, the hook locks into place so that the connector cannot be easily removed. Alternate embodiments provide other locking mechanisms for the connectors and the side frame parts.

The ends of the side frame parts may be solid, or partially or wholly hollow. In embodiments where the ends of the side frame parts are solid, the ends of the side frame parts take on the structure of the connector, and the connector is structured to receive the connector ends of the side frame parts.

FIG. 11 illustrates a front view of the parts of a modular frame kit in accordance to one embodiment of the present invention. The modular frame kit is comprised of an enclosure to store all the components of the modular frame system, including the canvas, and unassembled modular frame assembly, which comprises connectors (corner connectors, three-way connectors, and four-way connectors) and different sized side frame parts. FIG. 11 illustrates two side frame parts that are of different lengths and widths. The size of the connectors of the frame assembly correspond to the sizes of the side frame parts of the frame assembly, so when the side frame parts are attached to the connectors, the ends of the connectors fit properly inside the side frame parts so not to detach unexpectedly.

Furthermore, the modular frame kit may provide a tubular structure that holds the canvas during the transport of the modular frame kit, such as an art tube or poster tube.

FIG. 13 illustrates a front view of the parts of a circular modular frame assembly 1300 in accordance to one embodiment of the present invention. As mentioned with regards to other figures, the modular frame assembly may be connected together to form a circular frame. The circular modular frame kit 1300 comprises three way connectors 1330, curved frame parts 1310, straight frame parts 1320, and a radial connector 1350. The three way connectors 1330 connect to both the curved frame parts 1310 and the straight frame parts 1320 to form the structure of the modular frame assembly. The straight frame parts are also connected to the radial connector 1350. A canvas is draped over the modular frame assembly 1300 and tightened by elastic cables 1340.

FIG. 14 illustrates a front view of the parts of a quadrilateral modular frame assembly 1400. This quadrilateral modular frame assembly 1400 may be a modular portion of a larger modular frame assembly, or may exist as a distinct and separate modular frame assembly. The quadrilateral frame assembly 1400 of FIG. 14 comprises of straight frame parts 1410 and corner connectors 1420 to form the frame structure to display a canvas art. As shown in FIG. 14 and as mentioned with previous embodiments of the present invention, any number of elastic cables may tighten the canvas over the modular frame assembly in any arrangement.

FIG. 15 illustrates a back view of a modular frame assembly with a canvas to be draped over the modular frame assembly. In FIG. 15, the corner of a canvas may be draped and/or folded over modular frame assembly at a right angle so that the canvas appears smooth over the planes of the modular frame assembly. The dotted lines of FIG. 15 indicate the edges and creases of the canvas as the canvas is attached/draped/folded over the modular frame assembly.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A canvas frame system for facilitating dismounting, transporting, and replacing of a canvas, comprising:
a modular frame assembly; and
a plurality of elastic cords;
wherein
said canvas comprises at least two rivet holes, wherein the at least two rivet holes are located at sides of the canvas; and
said plurality of elastic cords connect the at least two rivet holes.

2. The canvas frame system of claim 1, wherein a grommet is attached to each of the at least two rivet holes.

3. The canvas frame system of claim 1, wherein the plurality of elastic cords are made of plastic.

4. The canvas frame system of claim 1, wherein the modular frame assembly is made of plastic.

5. The canvas frame system of claim 1, wherein the canvas comprises at least one folded side.

6. The canvas frame system of claim 5, wherein at least one support piece is inserted into the at least one folded side.

7. The canvas frame system of claim 6, wherein the at least one support piece comprises at least one corresponding rivet hole.

8. The canvas frame system of claim 1, wherein each of the plurality of elastic cords comprises a first hook located at a first end and a second hook located at a second end.

9. A modular frame assembly for a canvas display, for facilitating dismounting, transporting, and replacing of the canvas display, comprising:
at least one connector; and
a plurality of side frame parts, wherein the plurality of side frame parts connect to the at least one connector.

10. The modular frame assembly of 9, wherein the at least one connector comprises at least one three-way connector.

11. The modular frame assembly of 9, wherein the at least one connector comprises at least one four-way connector.

12. The modular frame assembly of 9, wherein the at least one connector comprises at least one corner connector.

13. The modular frame assembly of 9, wherein the at least one connector comprises ridges on at least one connecting end of the at least one connector.

14. The modular frame assembly of 9, wherein the at least one connector comprises a hook on at least one connecting end of the at least one connector.

15. The modular frame assembly of 9, further comprising a corner module.

16. A modular frame kit comprising:
at least one package, the package comprising a plurality of defined compartments, wherein each compartment serves as a dedicated storage location;
at least one three way connector;
a plurality of side frame members; and
a plurality of elastic cords.

17. The modular frame kit of claim 16, further comprising at least one four-way connector.

18. The modular frame kit of claim 16, further comprising at least one corner connector.

19. The modular frame kit of claim 16, further comprising at least one corner module.

20. The modular frame kit of claim 16, further comprising a tubular structure for containing a canvas.
